(19) United States
(12) Patent Application Publication
(10) Pub. No.: US 2015/0058056 A1
(43) Pub. Date: Feb. 26, 2015

(54) SYSTEMS AND METHODS FOR STREAMLINING SCHEDULING

(71) Applicants: Mark F. Comerford, Boston, MA (US); Ellen Comerford, Boston, MA (US)

(72) Inventors: Mark F. Comerford, Boston, MA (US); Ellen Comerford, Boston, MA (US)

(21) Appl. No.: 13/973,607

(22) Filed: Aug. 22, 2013

(51) Int. Cl. G06Q 10/10

(52) U.S. Cl. CPC G06Q 10/1095
USPC 705/7.19

(57) ABSTRACT

According to some embodiments, systems and methods for scheduling at least one time slot of a plurality of time slots is provided. The system includes a scheduling component configured to receive a first request to generate a suggested calendar entry, the first request including an identifier of a first profile associated with scheduling preference information, identify, based on the first profile, a plurality of characteristics of the suggested calendar entry, the plurality of characteristics including at least one characteristic specified by the scheduling preference information, determine, based on the plurality of characteristics, that a plurality of resources are available during the at least one time slot, and generate the suggested calendar entry for the at least one time slot, the suggested calendar entry having the plurality of characteristics and requesting the plurality of resources during the at least one time slot.

### BACKGROUND

1. Technical Field

The technical field generally relates to resource planning, and more particularly, to systems and methods for scheduling of events.

2. Background Discussion

Most people are familiar with the task of scheduling meetings, appointments and other events using a virtual calendar. Businesses catering to health and fitness related services use virtual calendars to schedule various resources such as professional staff, equipment, and rooms. Businesses will often provide clients with a web-based portal or other interface that enables clients to view available classes, make a reservation, and alter their previous reservations using these virtual calendars. In addition, front-desk employees and administrative staff may perform scheduling operations through similar interfaces.

Software that is designed to aid in the scheduling of events exists. The popularity of digital calendars such as Microsoft® Office Outlook® available from Microsoft Corp. of Redmond Wash. and Google Calendar available online from Google Inc. of Mountain View Calif. has largely homogenized the look-and-feel, function, and usability of existing systems. The traditional task of scheduling an event consists of selecting a time slot within a calendar, and entering various characteristics for the event. A user generally enters specific characteristics for the event using one or more windows and/or views and then submits the event to be published to the calendar. Once the event has been published, the event appears relative to the time slot in which the event coincides.

### SUMMARY

Aspects and embodiments disclosed herein present scheduling systems and methods that direct the creation of calendar entries in a manner that is simpler and more efficient than conventional scheduling systems. For instance, some embodiments disclosed herein manifest an appreciation that the creation of a calendar entry, such as a reservation for a service (e.g., a class, session, consultation, or the like), is largely duplicative and time consuming for users. To make matters worse, the task of creating calendar entries, or modifying existing calendar entries, is often complicated by large amounts of required fields, confusing and flawed interfaces (i.e., bugs). Therefore, many of these embodiments disclosed herein include a scheduling system and a user interface that ease the administrative burden associated with conventional scheduling systems. In some embodiments, the scheduling system maintains user profiles that are associated with characteristics of previously created calendar entries. The user interface provides an interface to the scheduling system which enables displaying of schedules, creating calendar entries, and modifying existing calendar entries. As explained further below, the user interface and scheduling system enable an unconventional level of simplicity in scheduling by leveraging user profiles to eliminate the necessity of entering redundant characteristics for calendar entries.

The scheduling systems and methods disclosed herein target a wide variety of industries which schedule based on resource availability. A non-limiting list of services that may perform scheduling using these systems and methods include fitness, personal training, physical therapy, salon services, spa services, massage therapy, yoga, Pilates, and martial arts. Other categories of resource scheduling may be addressed according to various embodiments. Thus, embodiments are not limited to services belonging to particular categories or possessing particular characteristics.

According to various aspects and embodiments, a system for scheduling at least one time slot of a plurality of time slots is provided. The system includes a memory, at least one processor coupled to the memory, and a scheduling component executable by the at least one processor and configured to receive a first request to generate a suggested calendar entry, the first request including an identifier of a first profile associated with scheduling preference information, identify, based on the first profile, a plurality of characteristics of the suggested calendar entry, the plurality of characteristics including at least one characteristic specified by the scheduling preference information; determine, based on the plurality of characteristics, that a plurality of resources are available during the at least one time slot; and generate the suggested calendar entry for the at least one time slot, the suggested calendar entry having the plurality of characteristics and requesting the plurality of resources during the at least one time slot.

In the system, the first profile may be a user profile that includes biographical information. In the system, scheduling preference information may be manually created. In the system, the scheduling component may be configured to generate the scheduling preference information based on at least one previous calendar entry.

In the system the scheduling preference information may include one or more characteristics from at least one previous calendar entry, and the scheduling component is configured to determine whether at least one characteristic of the plurality of characteristics of the suggested calendar entry matches the one or more characteristics of the at least one previous calendar entry, and apply, in response to determining the at least one characteristic matches the one or more characteristics, at least one other characteristic of the at least one previous calendar entry to the suggested calendar entry.

The system may be further configured to receive a second request to schedule the at least one time slot of the plurality of time slots, the second request including an identifier of a second profile, update the suggested calendar entry based on the second profile, and display the suggested calendar entry within a view, the view including a representation of the first profile and the second profile.

In the system, the plurality of resources may include at least one of an identified space (e.g., a physical space, such as a room, or logical space, such as slot within a service session or class slot), equipment, and a service provider (e.g., an instructor). Further, the plurality of characteristics of the suggested calendar entry may change based on a number of profiles associated with the suggested calendar entry.

In the system, at least one characteristic of the plurality of characteristics of the suggested calendar entry may be a default service type, and wherein the default service type is selected based on a characteristic of at least one of the scheduling preference information and the at least one time slot.

In the system, the at least one time slot may be configured by one or more characteristics, the one or more characteristics including a time period comprising at least one of a start time and an end time. In addition, the at least one time slot may be selected based on the first profile. Likewise, the at least one time slot may be configured with predefined characteristics.

In the system, the first request may be generated via a drag-and-drop operation. In addition, the first request may be generated via a natural language command.

According to another embodiment, a method of scheduling at least one time slot of a plurality of time slots is provided. The method includes acts of receiving a first request to generate a suggested calendar entry, the first request identifying a first profile associated with scheduling preference information, identifying, based on the first profile, a plurality of characteristics of the suggested calendar entry, the plurality of characteristics including at least one characteristic specified by the scheduling preference information, determining, based on the plurality of characteristics, that a plurality of resources are available during the at least one time slot, and generating the suggested calendar entry for the at least one time slot, the suggested calendar entry having the plurality of characteristics and requesting the plurality of resources during the at least one time slot.

The method may further include the act of identifying the plurality of characteristics of the suggested calendar entry to also including identifying the plurality of characteristics based on a first user profile, the first user profile including biographical information.

The method may further comprise the act of generating the schedule preference information manually. In addition, the method may further comprise the acts of generating the schedule preference information based on at least one previous calendar entry, the at least one previous calendar entry having a plurality characteristics.

In the method, the plurality of characteristics of the suggested calendar entry may include at least one resource and generating the suggested calendar entry includes the acts of determining that the at least one resource is unavailable for the at least one time slot, and suggesting, responsive to determining that the at least one resource unavailable, another resource which is available for the at least one time slot.

The method may further include the acts of receiving a second request to update the suggested calendar entry for the at least one time slot of the plurality of time slots, the second request identifying a second profile, updating the suggested calendar entry based on the second profile, and displaying the suggested calendar entry within a view, the view including a representation of the first profile and the second profile.

In the method, the act of determining at least one characteristic of the plurality of characteristics may be based on at least one scheduling pattern. In the method, the act of determining at least one characteristic of the plurality of characteristics based on at least one scheduling pattern may further include the act of determining the scheduling pattern based on at least one previous calendar entry associated with the scheduling preference information.

In yet another embodiment, a non-transitory computer readable medium storing instructions for scheduling at least one time slot of a plurality of time slots is provided. The instructions being executable by at least one processor of a computer system, and the instructions configured to instruct the computer system to receive a first request to generate a suggested calendar entry, the first request including an identifier of a first profile associated with scheduling preference information, identify, based on the first profile, a plurality of characteristics of the suggested calendar entry, the plurality of characteristics including at least one characteristic specified by the scheduling preference information, determine, based on the plurality of characteristics, that a plurality of resources are available during the at least one time slot, and generate the suggested calendar entry for the at least one time slot, the suggested calendar entry having the plurality of characteristics and requesting the plurality of resources during the at least one time slot.

In the non-transitory computer readable medium the first profile may be a user profile that includes biographical information.

In the non-transitory computer readable medium the instructions may be further configured to instruct the computer system to generate the schedule preference information based on at least one previous calendar entry.

In the non-transitory computer readable medium the plurality of resources includes at least one of an identified space (e.g., a physical space, such as a room, or logical space, such as slot within a service session or class slot), equipment, and a service provider (an instructor).

In the non-transitory computer readable medium the plurality of characteristics may be determined based on at least one scheduling pattern. In addition, the at least one scheduling pattern is determined by at least one previous calendar entry associated with the scheduling preference information.

In the non-transitory computer readable medium the at least one time slot includes at least one calendar entry indicating availability of the resource. In the non-transitory computer readable medium the at least one time slot includes at least one scheduling preference indicator, the scheduling preference indicator indicating at least one predefined characteristic of the at least one time slot.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed subject matter. Particular references to examples and embodiments, such as “an embodiment,” “an example,” “another embodiment,” “another example,” “some embodiments,” “some examples,” “other embodiments,” “an alternate embodiment,” “various embodiments,” “one embodiment,” “at least one embodiments,” “this and other embodiments” or the like, are not necessarily mutually exclusive and are intended to indicate that a particular feature, structure, or characteristic described in connection with the embodiment or example and may be included in that embodiment or example and other embodiments or examples. The appearances of such terms herein are not necessarily all referring to the same embodiment or example.

Furthermore, in the event of inconsistent usages of terms between this document and documents incorporated herein by reference, the term usage in the incorporated references is supplementary to that of this document; for irreconcilable inconsistencies, the term usage in this document controls. In addition, the accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a block diagram of a scheduling system;

FIG. 2 is an illustration of a calendar-centric user interface;

FIG. 3 is another illustration of a calendar-centric user interface;

FIG. 4 is another illustration of a calendar-centric user interface;

FIG. 5 is a flow diagram of a method for generating a suggested calendar entry; and

FIG. 6 is a block diagram of one example of a distributed computer system that may be used to perform processes and functions disclosed herein;

### DETAILED DESCRIPTION

Some embodiments disclosed herein include systems and methods for processing scheduling requests. For example, according to one embodiment a scheduling system executes a process that receives a request to generate a suggested calendar entry. The request includes at least one identifier of a profile (e.g., a user profile, a resource profile, or profiles for other entities involved in scheduled events). In response to receiving the request, the system generates a suggested calendar entry based in part on characteristics of previously created calendar entries within the system. For instance, systems and methods in accord with some examples identify one or more preferences of users associated with a profile. Scheduling preferences may include any characteristic of previously created calendar entries and automatic entry of these scheduling preferences enable the generation of suggested calendar entries with minimal user input. In some examples disclosed herein, the suggested calendar entries may automatically become calendar entries with minimal or no further user input. It should be understood that a suggested calendar entry, in some embodiments, includes all of the characteristics necessary to generate a calendar entry within the system. In still other examples, a user may confirm that a suggested calendar entry includes the characteristics the user desires for an event. During the confirmation of a suggested calendar entry, a user may alter one or more characteristics of the event.

In some embodiments discussed further below, if a previously created calendar entry includes characteristics pertinent to, and associated with, a new scheduling request, than the characteristics of the previously calendar entry will substantially comprise the suggested calendar entry and be used in lieu of additional user input. A suggested calendar entry is any calendar entry which has been determined, at least in part, by examination of scheduling preferences and patterns of a particular profile (e.g., a user profile, a resource profile such as a profile for a service provide (e.g., an instructor) or an identified space, etc). A calendar entry, as used herein, denotes any schedulable/scheduled event which may be visualized within a calendar, stored within a data store, and utilized in subsequent scheduling processes. Examples of calendar entries include representations of schedulable services such as classes (e.g., spinning, Pilates, etc) and sessions (e.g., acupuncture, facials, etc).

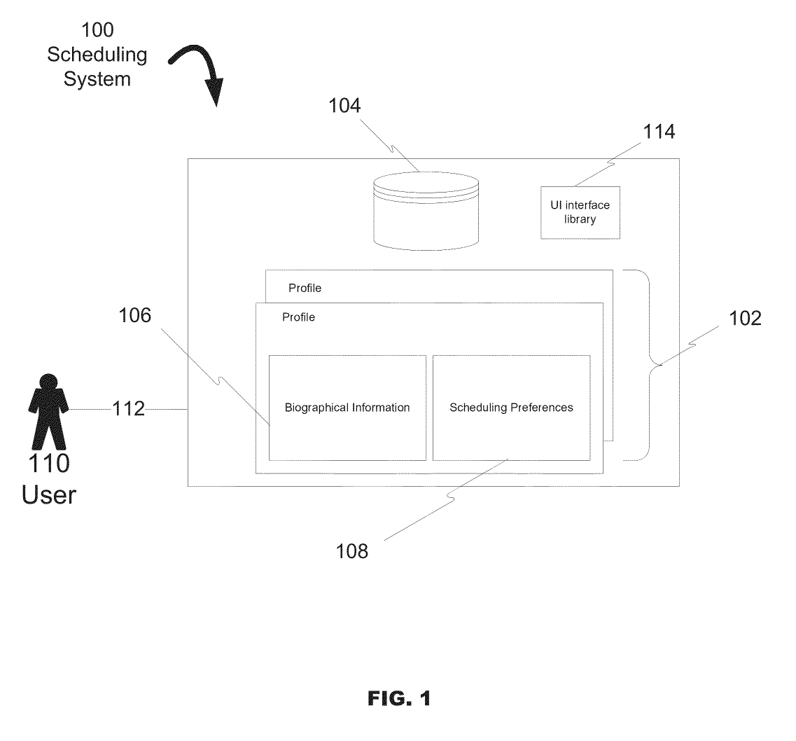

Additionally, in some examples, a user profile may include one or more sub-profiles. In these examples, the sub-profiles may be used to organize and delineate previous scheduling requests depending on a characteristic or preference, such as a class type. For example, scheduling requests pertaining to fitness services may be contained within a particular sub-profile. Likewise, scheduling requests pertaining to other services such as spa services may be contained in one or more other sub-profiles. As will be described further below with regards to FIGS. 1-5, these sub-profiles may then be used by the scheduling system and user interface to stream-line future scheduling requests.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

### Profile-Driven Scheduling System

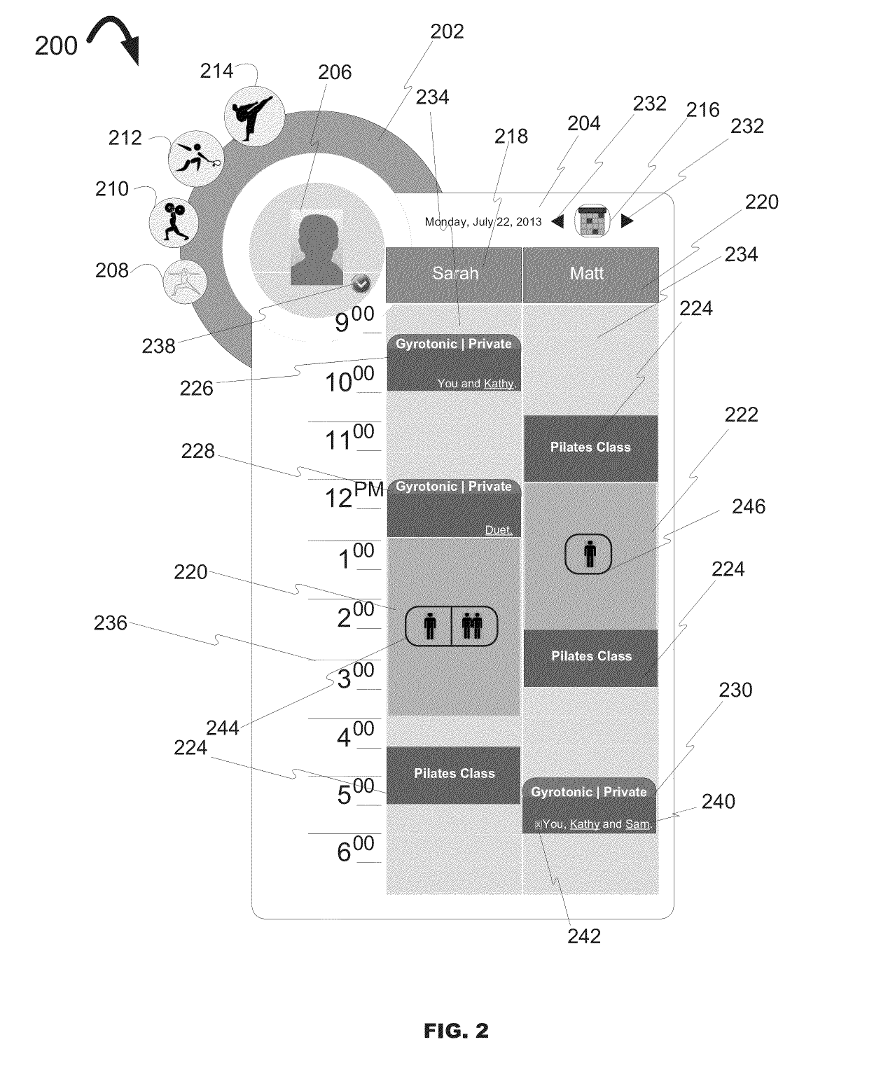

Various examples disclosed herein relate to scheduling and displaying calendar entries based on profiles. As explained further below, examples of profiles demonstrate a range of the information that may be obtained, interpreted, and associated with a profile, and how such information may be organized and delineated in a manner that aids in the creation of future calendar entries. In these examples, a profile-driven scheduling system utilizes the profiles as one source of underlying data for a calendar-centric user interface, such as those discussed further below with reference to FIGS. 2-4. FIG. 1 illustrates an example scheduling system.

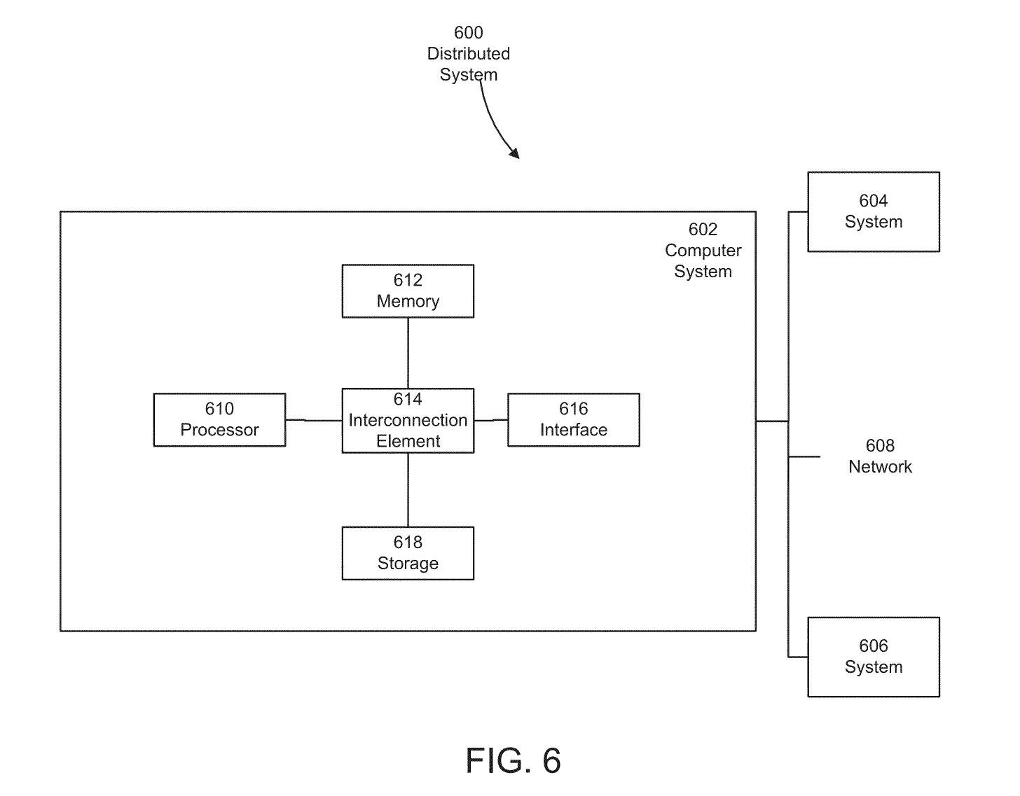

FIG. 1 includes a scheduling system generally indicated at 100 that is accessed by a user 110 via a network 112. According to various examples, the scheduling system 100 is implemented using one or more computer systems, such as the distributed computer system 600 discussed below with regard to FIG. 6. In these examples, a user may access the scheduling system 100 using the network 112 (e.g., via a smart phone or other computer system using an application or web-based interface) or may directly access the scheduling system 100. Thus, examples of the scheduling system 100 include a variety of hardware and software components configured to perform the functions described herein and examples are not limited to a particular hardware component, software component, or particular combination thereof. It should be understood that the scheduling system 100 may be a cloud-based service provide scheduling functionality to multiple businesses who subscribe. Users accessing the scheduling system 100 may view one or more user interface components which are branded (i.e., private labeled) to a particular business subscriber.

Still referring to FIG. 1, the network 112 may include any communication network through which computer systems (i.e. send or receive) information. For example, the network 112 may be a public network, such as the internet, and may include other public or private networks such as LANs, WANs, extranets and internets. As shown, the user 110 may utilize the network 112 to exchange data with the scheduling system 100. For example, the user 110 may access the scheduling system 100 using the network 112 from a remote computer system or from a mobile device such as a laptop or smart phone.

In addition, information may flow between the elements, components and subsystems described herein using a variety of techniques. Such techniques include, for example, passing the information over the network 112 using standard protocols, such as TCP/IP, passing the information between modules in memory and passing the information by writing to a file, database, or some other non-volatile storage device. In addition, pointers, identifiers, or other references to information may be transmitted and received in place of, or in addition to, copies of the information. Conversely, the information may be exchanged in place of, or in addition to, pointers, identifiers, or other references to the information. Other techniques and protocols for communicating information may be used without departing from the scope of the examples disclosed herein.

In the illustrated example, the scheduling system 100 includes one or more profiles indicated at 102, a data store 104, and UI interface library 114. The one or more profiles 102 include biographical information 106, and scheduling preference information 108. As discussed further below, the data store 104 may be configured to store the one or more profiles 102 and associated data, calendar entries, and resource information. As referred to herein, a resource may identify any schedulable resource such as people (including service providers such as staff, instructors, practitioners, beauticians, therapists, etc), equipment, identified physical spaces (e.g., rooms), identified logical spaces (e.g. a slot within a service to be provided, such as a class slot) and the like. Resources may be associated with each other, such as an identified space may be associated with equipment. The scheduling system 100 receives scheduling requests and generates suggested calendar entries based on the biographical information 106, and the scheduling preferences 108 of an identified profile. The identified profile may belong to the user 110, a user associated with the user 110, or a resource (e.g., an identified physical space). Upon receiving a scheduling request, the scheduling system 100 generates a suggested calendar entry by identifying one or more characteristics for the calendar entry which may be satisfied using information contained within the biographical information 106 and the scheduling preferences 108 associated with the identified profile. Although examples disclosed herein are directed to user profiles, it should be understood that any given schedulable resource or other entity may also have a profile. For example, an identified physical space (e.g., a room) may have a profile which allows staff/professionals of a business to establish available timeslots for the identified physical space, available equipment, etc.

In the example shown, the scheduling system includes a UI interface library 114. The UI interface library 114 includes a plurality of user interface components that are specially configured for display in conjunction with a calendar control. As with other components of the system, these specialized user interface components may include data structures and executable instructions. In addition, the user interface library 114 provides a system interface through which other system components, such as the user interface 200 discussed further below with reference to FIG. 2, can request instantiation of the components housed within the library. Some examples of visualizations created by these specialized user interface components are discussed further below with regard to FIGS. 2-4.

According to the example illustrated in FIG. 1, the scheduling system 100 resides on a distributed computer system, such as the distributed computer system 600 discussed below with regard to FIG. 6. However, as explained with regard to FIG. 2 below, other examples may arrange system components in a variety of configurations. For instance, in some examples, the UI interface library 114 resides on at least one client system, such as computer system 604 (FIG. 6).

The data store 104 depicted in FIG. 1 includes components that store and retrieve scheduling related information. In general, this scheduling information may include any information associated with scheduling requests and the profiles 102. Scheduling related information may consist of, for example, class schedules, service provider availability, and equipment availability. In addition, previously created calendar entries may be stored within the data store 104. These previously created calendar entries may be stored in a central data location (e.g., a table) within the data store 104 or may be held in separate tables (e.g., one table per user profile). Information pertaining to users of the scheduling system 100 may include information for clients and/or staff. In various examples, this information comprises the biographical information 106 and may include name, address, date of birth, membership status, date of enrollment, etc., for a user. In these examples, the biographical information may also include information relating to staff/professionals and other schedulable resources. For instance, information descriptive of a date of hire, training certifications and service specialties of a schedulable profession may be contained within the data store 104. In addition, the scheduling preferences 108 of a service provider (e.g., staff member/professional) and/or other resources may be used by the scheduling system 100 when determining one or more characteristics for calendar entries, such as general availability, service types offered and service capacity (e.g., class size). It is to be appreciated that the scheduling system 100 may determine service capacity using one or more factors including the physical space in which the service will occur, the equipment available, and preferences of the service provider.

The data included in the data store 104 may be gathered and interpreted from a wide variety of sources. For instance, in an example directed to fitness centers, data may be imported from existing scheduling systems. In this example, the imported data may include clients and/or staff's biographical information such as full name, address, phone number and status (e.g., membership status, employee status). In addition, the data may include previously created calendar entries and associated characteristics. For instance, data from previously created calendar entries may be stored verbatim, may be summarized, or may be partitioned with only particular elements being imported. Subsequent scheduling requests by the user 110 may be streamlined by such preferences so that a minimal amount of user input is required to generate a suggested calendar entry. Other examples of data importation include the gathering of information from social media websites such as Facebook available online from Facebook of Menlo Park, Calif. For example, in one embodiment the biographical information for a user profile may be comprised of a reference to a Facebook profile which may be queried for additional biographical information. In another example, a user profile may be shared by one or more businesses who subscribe to the cloud-based scheduling system 100 described above. In this example, the scheduling preferences 108 and/or scheduling patterns (discussed further below) may be shared and utilized between subscribing business.

In at least one embodiment, data within the data store 104 may also be generated and/or modified manually. For example, user profiles may be generated via a user interface using one or more windows and/or views. Likewise, conventional scheduling requests may be utilized to generate and/or modify the scheduling preferences 108. In one embodiment, a template user profile may be created and used to create the user profiles 102. In this embodiment, the template user data may include information descriptive of an existing user that is duplicated (i.e., copied) to create a new user with the same scheduling preferences 108.

According to various embodiments, data within the data store 104 may be interpreted to identify scheduling patterns of a users and resources. These scheduling patterns may be the basis for one or more preferences included within the scheduling preferences 108. Statistical analysis of scheduling preferences may inform the generation of suggested calendar entries. For example, if data within a user profile suggests that a user statistically prefers morning classes related to Pilates (e.g. registers for morning Pilates classes more than a threshold percentage of the time) and evening classes related to Spinning, these preferences may be represented and associated with the scheduling preferences 108. In another example, scheduling patterns with the greatest frequency are more likely to form the basis of a suggested calendar entry. For example, if a user most frequently schedules Pilates activities, then the scheduling system 100 will be more likely to suggest a calendar entry including characteristics pertinent to Pilates. The characteristics themselves may be further narrowed based on statistical analysis of the scheduling preferences 108. In the previous example, the characteristics pertinent to Pilates may include resources most frequently selected such as a particular Pilates instructor, most frequently selected equipment for Pilates, etc.

In other examples, the most recent scheduling patterns of a user may be given priority (e.g., more weight) during the generation of suggested calendar entries. Still further examples may include the scheduling system 100 determining one or more underlying associations between previous calendar entries. As discussed above, temporal relationships between calendar entries may provide an indication of a preferred time of day to include in a suggested calendar entry. Other underlying factors may include any relatable characteristic of previous calendar entries such as time of day, day of week, service provider gender preferences (e.g., always selecting female service providers), average timeslot duration (e.g., length of sessions), etc.

Likewise, the scheduling patterns of a staff/professional users and/or resources (e.g., an identified physical space) may be interpreted to determine one or more preferences associated with the scheduling preferences 108. As discussed further below, these preferences may be organized into sub-profiles. In addition, data from all user profiles may be interpreted globally and used advantageously by front-desk staff and managers. For example, identifying patterns of usage based on the time of year and impact of promotional offers on enrollment and class attendance may aid in the allocation (i.e., scheduling) of resources. In this example, the scheduling system 100 may determine that additional classes or service providers should be available to accommodate seasonal demands. Such determinations may be provided to the user 110 via components of the UI interface library 114.

One skilled in the art, having the benefit of reading this disclosure, would recognize that any data within the data store 104 may be analyzed and interpreted to determine one or more scheduling patterns to generate scheduling preferences therefrom. In addition, the data within the data store 104 may pertain to one or more subscribing businesses and be used to analyze and determine scheduling patterns.

Data, including scheduling requests, previously created calendar entries, biographical data, and scheduling preferences, may be stored in the data store 104 in any logical construction capable of storing information on a computer readable medium including, among other structures, flat files, indexed files, hierarchical databases, relational databases or object oriented databases. The data may be modeled using unique and foreign key relationships and indexes. The unique and foreign key relationships and indexes may be established between the various fields and tables to ensure both data integrity and data interchange performance.

In one embodiment, the user profiles 102 may be based on flexible associations between data within the data store 104. To this end, the user profiles 102 may simply be a linking table which associates the biographical information 106 and the scheduling preferences 108. In another embodiment, the user profiles 102 may be stored with both the biographical information 106 and the scheduling preferences 108 within the same data structure.

In one embodiment, each time a user submits a suggested calendar entry to the scheduling system 100, characteristics of the calendar entry are recorded, categorized and used to further define the scheduling preferences 108 for a profile. For example, when a user 110 schedules a private Pilates session with an instructor, various characteristics of the calendar entry such as date and time, instructor name, and special instructions (i.e., notes from the user to the instructor indicating personal preferences of the user) are stored within the schedule preferences 108. In this example, a profile associated with the user 110 may include a sub-profile referenced as “Pilates.”

### User Interface Examples

As discussed above with reference to FIG. 1, the scheduling system 100 processes scheduling requests received from external entities such as the user 110 through the UI interface library 114. According to some examples, the UI interface library 114 includes components that are visualized in a user interface such as a calendar-centric user interface discussed below with reference to FIGS. 2-4. These interactive components may include specially configured user interface components. In at least one example, the interactive components enable a user to perform various scheduling tasks with a minimal amount of input from the user 110.

FIG. 2 illustrates one embodiment of a calendar-centric user interface generally indicated at 200. The user interface includes a user profile frame 202, and a calendar frame 204. According to various embodiments the visualized elements of the user profile frame 202 and the calendar frame 204 may be provided by the UI interface library (FIG. 1), and visualized in various ways.

According to the embodiment shown in FIG. 2, the user profile frame 202 and the calendar frame 204 are presented in a manner where both are visible to a user. In one embodiment, the user profile frame 202 may change its visible state based on mouse events. For instance, the user profile frame 202 may be hidden in a collapsible view, or slide-out tray, and may be expanded (i.e., visualized) in response to a mouse-over event. Likewise, the loss of mouse focus may result in the user profile frame 202 being hidden from view.

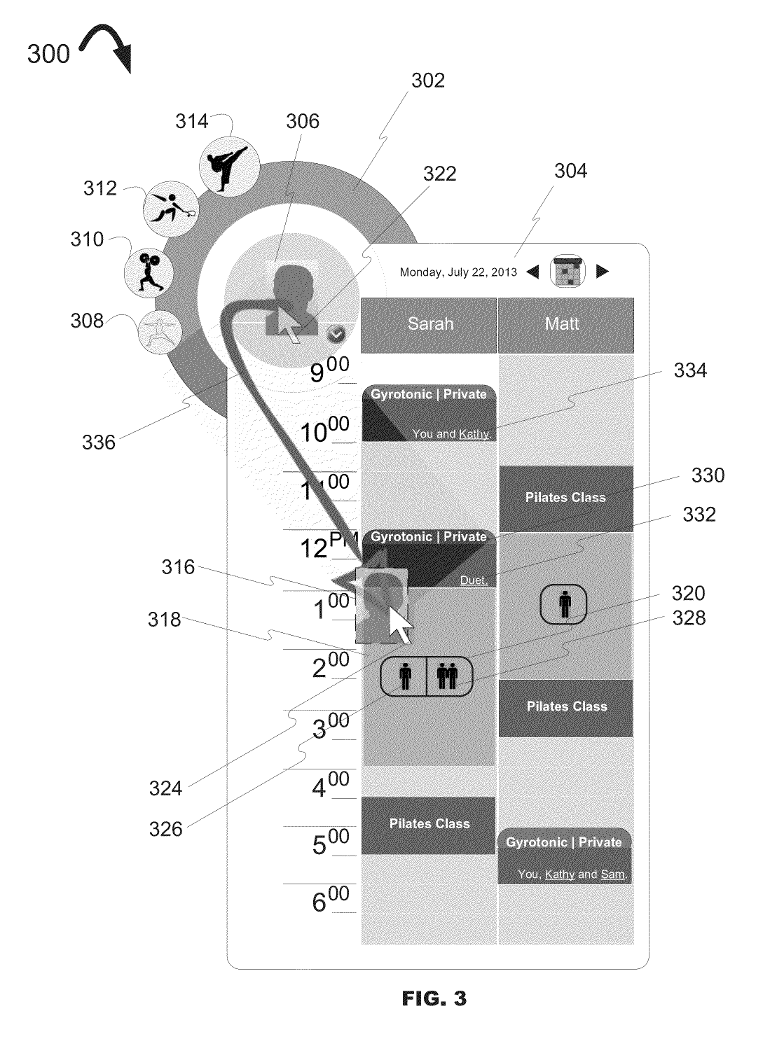

In the embodiment illustrated in FIG. 2, the user profile frame 202 is illustrated as a radial dial including a primary profile representation 206, sub-profile representations 208-214, and a profile selection element 238. In one embodiment, the primary profile representation 206 visualizes at least a portion of the biographical information 106 (FIG. 1) of a user profile. For example, in the shown embodiment, the primary profile representation 206 is a silhouette of a male indicating that the biographical information relates to a male user. In other examples, a photograph or user-selectable avatar (e.g., a Facebook profile image) may be utilized. Likewise, sub-profile representations may include stock images or user-selected images for display. In at least one embodiment, only the main profile representation 206 is displayed. It should be understood that the user profile frame 202 may be dynamically updated based on the data within an underlying user profile. The biographical information 106 and the scheduling preferences 108 of the underlying user profile provide numerous properties for displaying the primary profile representation 206. A non-limiting list of properties may include a user's name, date of birth, membership status and role (e.g., client or employee). As will be further discussed below with regard to FIG. 3, the primary profile representation 206 may be used during drag-and-drop operations that enable the creation of calendar entries without requiring additional user input from the user 110.

In addition, the scheduling preferences 108 (FIG. 1) within the user profile may be the basis for the sub-profile representations 208-214. For example, users who have previously scheduled Pilates classes may have the sub-profile 208 displayed. The order, magnitude, and placement of the sub-profiles 208-214 may also be based on the scheduling preferences 108 (FIG. 1). For example, if the most recent calendar entry is related to Karate, the Karate sub-profile 214 may be sized slightly larger than the other displayed sub-profiles, and placed in a position on-screen which is prominent to a user's eye. In this example, the size and relative position of previously created calendar entries using sub-profiles visualizations are arranged in a descending order where the most recently scheduled calendar entry appears first. In other examples, such arrangement may be based on configurable preferences. For instance, a user may manually configure their profile to always display a certain sub-profile in a prominent manner. In still other examples, the arrangement of sub-profiles may be based on the frequency in which a particular service type is scheduled (e.g., massage sessions, Pilates, etc). As will be further discussed below with regard to FIG. 3, the sub-profiles representations 208-214 may be used during drag-and-drop operations which enable creation of calendar entries without requiring additional user input from the user 110.

In one embodiment, the profile selection element 238 may be used to open one or more views for configuring a profile. In one embodiment, the profile selection element 238 may be a profile drop-down button. In this embodiment, configuration views, wizards, and other conventional methods of modifying a user profile may be utilized. In addition, the profile selection element 238 may allow a user to switch the user profile frame 202 to display a different profile. In this example, a user may view and manage their own profile and also associate (schedule) the profile of others with calendar entries.

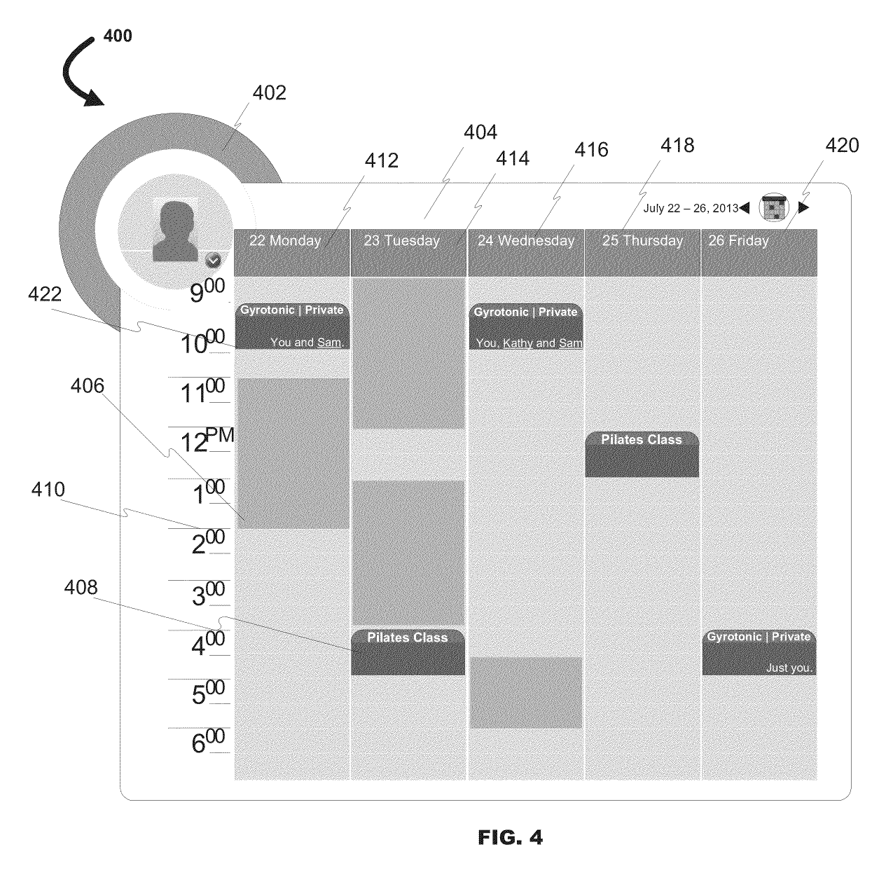

Still referring to FIG. 2, the calendar frame 204 includes a time range selector 216, schedulable resources 218-220, available timeslot indicators 220-222, scheduled classes at 224, and scheduled private classes at 226-230, and a time-span representation 236. In the shown embodiment, the schedulable resources 218-220 are service providers (e.g., instructors). In other embodiments, any schedulable resource may appear at 218-220 including identified physical spaces (e.g., rooms), identified logical spaces (e.g., a slot in a class), equipment, or other resource. Likewise, in the shown embodiment, the scheduled classes 224 are of a particular service type available for scheduling. In other embodiments, the scheduled classes 224 may be other service types including sessions for physical therapy, facials, acupuncture, etc. According to the shown embodiment, the schedulable resources 218 and 220 are used as column headers for the plurality of timeslots 234 for each respective resource. In these embodiments, the schedule for a given resource may be represented using different time range representations. In the shown embodiment, the time range representation 236 is based on the hours of operation (i.e., normal business hours). In other embodiments, the time range may be configured with more precise granularity and may represent a small window of time (i.e., an hour or two) up to an entire year. One example of a particular time range may be found further below in reference to FIG. 4. In various embodiments, a user may specify a desired time range, or a particular window of time using the time-range selector 216. The time-range selector 216 may be configured with a forward/back advancement control 232 to enable selection of a particular time range. For instance, in the shown embodiment, the displayed schedule is based on a particular day of the week and selecting the advancement control 232 changes the currently selected day to either the previous day or the next day.

In some embodiments, the time range representation 236 may be altered by mouse and keyboard operations. For example, scrolling a mouse wheel over the calendar frame 204 may adjust the displayed time range representation 236 by zooming in and out (i.e., narrowing the displayed time range and broadening the displayed time range). In at least one embodiment, scrolling out may cause the calendar frame 204 to transition to displaying one or more other schedule representations. For example, scrolling out may change the schedule frame 204 to display the calendar frame 404 in FIG. 4. In another example, the time range selector 216 may include an icon which enables a user to select a different time range to be displayed. Changing the schedule frame 204 may advantageously enable larger time ranges to be represented while still maintaining a user's ability to review schedules and make modifications.

In the embodiment shown, various calendar entries (224, 226 and 228) are displayed in columns beneath the schedulable resources headers 218-220. The various calendar entries are visualized against the time range representation 236 based on characteristics of the calendar entries (e.g., start time, end time, etc). In addition, the various calendar entries may be visualized according to various characteristics pertaining to the calendar entry. For example, group classes 224 may be represented in an “open class” manner and will exclude any restriction visualization. In contrast, private calendar entries (e.g., calendar entry 226-230) may indicate a “private” status indicator in the form of a title or icon indicating the calendar entry is restricted to a certain user or users. Calendar entry 230 illustrates one example of a private calendar entry with an associated status indicator 240 which is visualized in a plain English syntax. Other embodiments may illustrate status indicators using icons such as a lock or exclamation point. It should be understood that any characteristic of a calendar entry may be used when visualizing calendar entries such as calendar entry 240. This includes, but is not limited to, displaying images associated with one or more associated users (e.g., a Facebook profile picture, an avatar, etc), setting a background color of the displayed calendar entry, and providing highlighting in the form bolding or other accentuations.

In addition, it should be understood that scheduling operations may be enabled by visualized controls within a displayed calendar entry. For example, calendar entry 230 includes a scheduling function button 242. In the embodiment shown in FIG. 2, the scheduling function button 242 enables a user to remove (or dissociate) their user profile from an existing calendar entry. In other embodiments, other scheduling function buttons/controls may be visualized. For example, a button may be visualized which enables additional user profiles to be associated with the calendar entry (e.g., a plus sign). Still other examples include the ability to execute functions related to one or more user profiles associated with calendar entry. For example, the status indicator 240 may include hyper-links which enable information to be viewed about other user profiles associated with the calendar entry 230.

A given resource may not be available to schedule over an entire time range. In one embodiment, time slot availability may be indicated by one or more visual representations such as the available time slot indicators 220 and 222. In this embodiment, a user may determine a time slot is available based on the coloration of the timeslot indicators 220 and 222. In addition, a user may determine a particular preference/restriction the available timeslot has. For example, the available time slot indicators may include a preference indicator such as preference indicators 244 and 246. The preference indicators 244 and 246 may visualize one or more preferences for a given time slot. For example, preference indicator 244 indicates that private and/or group sessions (classes) may be scheduled within the available slot. In contrast, preference indicator 246 indicates that only private sessions may be scheduled. Using the preference indicators 244-246 users may be able to quickly determine which available time slots are open to the type of calendar entry they wish to schedule. Further examples illustrating the use of preference indicators and available time slot indicators are discussed below with reference to FIGS. 3-4.

In other embodiments additional, visualizations may indicate a preference of a given available time slot. For example, in one embodiment karate may be a preferred class for the available time slot 222. In this embodiment, a karate icon or other visualization indicating karate may be used as the preference indicator 246. In another example, the preference indicator may visualize a resource availability identifier such as an equipment availability identifier. In this example, a user may easily identify a timeslot which includes the desired number of available equipment based on the equipment availability identifier. After identifying the time slot with the desired equipment available, the user may execute an operation (e.g., drag-and-drop as discussed below with reference to FIG. 3) referencing the preference indicator which schedules the timeslot as a “trio” (i.e., reserving the equipment for themselves and two others). Subsequently, two other user profiles may be associated with the scheduled trio using one or more of the operations discussed further below. In yet another example, the scheduling system 100 may identify that a user is requesting to create a calendar entry in which they typically reserve certain equipment or other resources (i.e., a particular trainer, tanning room, massage therapist, etc.). If such a request exceeds the available resources, a user may be prompted with one or more suggestions to alternatively satisfy the request. In one embodiment, the suggestion may include an alternate day/time for the calendar entry. In another embodiment, the suggestion may include an alternate trainer, identified space (e.g., room), or other comparable resource.

As discussed with regards to FIG. 2, the primary profile representation 206 and sub-profile representations 208-214 may be used to generate a suggested calendar entry via a drag-and-drop operation of the mouse cursor. It should be understood that the drag-and-drop operation may also be performed using a gesture on a touch screen of a touch-sensitive device, such as a tablet and smart phone. FIG. 3 illustrates another embodiment of the calendar-centric user interface 200 from FIG. 2 generally designated at 300. The calendar-centric user interface 300 includes a user profile frame 302, and a calendar frame 304. The user profile frame 302 includes a primary profile representation 306 and sub-profile representations 308-314. The calendar frame includes an available time slot indicator 318, a scheduled private group calendar entry 330, a preference indicator 320, and a drag-and-drop path 336 of the primary profile representation 306. As discussed about with reference to FIG. 1, the primary profile representation and/or the sub-profile representations 308-314 may be used to create a calendar entry via a drag-and-drop operation. In one embodiment, a user may select a profile representation to drag, such as the profile located at the first mouse position 322. The dragged profile 316 may then be dragged over the available time slot indicator 318 as indicated by the mouse drag path arrow 336. Once the cursor is at a second position 324 over the time slot indicator 318, a user may drop (release) the dragged profile 316 over the time slot indicator 318. In one example, the user drops the dragged profile 316 over any region of the available time slot indicator 318 to generate a suggested calendar entry.

In various embodiments, the act of selecting a profile representation to drag may cause one or more calendar entries and the available time slot indicator 318 to change visual state. For example, the selection of the sub-profile representation 308 may cause all of the non-Pilates classes to be hidden from view. In an alternate example, the selection of the sub-profile representation may cause all of the Pilates calendar entries (e.g., calendar entry 330) to become highlighted. The highlighting of calendar entries based on profile selection may aid a user in identifying calendar entries pertaining to a particular profile or sub-profile which they are most interested in scheduling. In another example, selection of a profile representation may cause the available time slot indicator 318 to change visual state. In this example, selection of the primary profile representation 306 may cause the time slot indicator 318 to be visualized while deselecting may cause the time slot indicator 318 to be hidden from view. In still another example, selection of a profile representation may cause the available time slot indicator 318 to display a preference indicator, such as a resource availability indicator as discussed above with reference to FIG. 2. It should be understood that selection of a profile representation may also be performed by hovering or by focusing over a particular profile representation. For example, a mouse cursor hover over, or a finger hover-over in a hover-over enabled tablet or smart phone, may select a profile representation according to the examples disclosed above.

In one embodiment, the drag-and-drop operation may be performed utilizing the scheduling preference indicator 320. In this embodiment, a user may release the dragged profile 316 over the preference indicator 320. For example, if the dragged profile 316 is released over the private preference indicator 326, a suggested calendar entry will be generated with one characteristic set as a private session. Conversely, if the dragged profile 316 is released over the private group preference indicator 328, a suggested calendar entry will be generated with the characteristic of being a private group calendar entry. In another example, the dragged profile 316 may be dropped over the private group calendar entry 330. In this example, the scheduling system 100 (FIG. 1) determines if the dragged user profile 316 is allowed to join the private group calendar entry 330. If the scheduling system 100 (FIG. 1) determines that the dragged user profile 316 is allowed to join the private group calendar entry 330, the scheduling system 100 (FIG. 1) may provide a confirmation to the user to indicate the success of the scheduling operation.

In one embodiment, the confirmation may be a change in the calendar entry status 332. In this embodiment, the calendar entry status 332 may be changed from the status of “Duet” to that of “Trio” to indicate that three user profiles are associated with the private group calendar entry 330. In another embodiment, the calendar entry status 332 may be changed to include an indication that the user's profile has been associated with the calendar entry in addition to an indication of other profiles already associated with the calendar entry, such as the example calendar entry status at 334. As will be discussed below with regard to FIG. 4, responsive to a drag-and-drop operation, the scheduling system 100 (FIG. 1) may receive the request to generate a suggested calendar entry and determine one or more characteristics that may be satisfied from the scheduling preferences 108 (FIG. 1) in order to create a calendar entry in the scheduling system 100 (FIG. 1) and perform associated processes. It should be further understood that certain other operations executed by the user may also execute functions of the scheduling system 100 (FIG. 1). For instance, as discussed with reference to FIG. 2, visualized controls within the calendar frame 204 (FIG. 2) may execute scheduling functions such as those similar to drag-and-drop. In various embodiments, scheduling function controls (e.g., scheduling function control 242 of FIG. 2) enable operations that include, but are not limited to, generating a suggested calendar entry, confirming a suggested calendar entry, modifying a suggested calendar entry, modifying an existing calendar entry, removing an existing calendar entry, disassociating/associating user profiles with existing calendar entries, viewing user profile information, and manipulating the displayed time range.

In other embodiments, the scheduling system 100 (FIG. 1) may be configured to process natural language commands (e.g., commands generated from written or spoken words). Natural language commands may be embodied in various electronic forms and may be exchanged with users via one or more interfaces. Examples of natural language commands include recorded audio signals received via a microphone or other sound recording apparatus and text messages received via a keyboard or other text input mechanism. In one embodiment the scheduling system 100 (FIG. 1) includes a voice-enabled system through which users execute natural language commands by speaking the commands and receive audio responses from the scheduling system 100. In another embodiment, the scheduling system 100 (FIG. 1) includes a text message-enable system through which users execute natural language commands by generating text messages and receive text message responses from the scheduling system 100.

In some embodiments, the user 110 (FIG. 1) may access the scheduling system 100 via a computer system, such as the computer system 602 in FIG. 6. The computer system may be a kiosk-based computer positioned within a business for the purpose of providing users a convenient location to perform scheduling related tasks. The computer system may also be a mobile computing device such as a smart phone or laptop computer. Within the context of a voice-enabled scheduling system 100, the computer system may include a microphone and speakers. In these embodiments, the user 110 (FIG. 1) may generate a suggested calendar entry by speaking one or more natural language commands. For instance, the spoken commands may be as simple as “schedule me for Pilates for 11 am,” which would cause the scheduling system 100 (FIG. 1) to generate a suggested calendar entry for the Pilates Class 330 based on the user profile associated with the user 110.

It is to be appreciated that natural language commands may involve several parameters and require the scheduling system 100 to execute one or more complex processes. For example, a voice command such as “schedule me for a private Gyrotonic session with Matt” may cause the scheduling system 100 (FIG. 1) to determine the characteristics for the suggested calendar entry requested in the command based on data within the data repository 104 (FIG. 1) (e.g., the user profile) and external data such as the current date and time. In this example, the current date and the resource's availability will be analyzed by the scheduling system 100 (FIG. 1) to suggest and/or automatically create the suggested calendar entry. In some situations the resource may be unavailable at the requested time. In this situation, the scheduling system 100 may prompt the user with suggestions for alternate resources that are available to satisfy the request. For example, if Matt is requested but is unavailable, the scheduling system 100 (FIG. 1) may suggest another trainer who is available to the user 110 (FIG. 1) via an audio response transmitted to the user's mobile computing device.

In another embodiment, the characteristics may not be fully satisfied by the natural language command and the available data. In this embodiment, the scheduling system 100 (FIG. 1) may prompt the user for additional details to generate a suggested calendar entry. The prompt may be on-screen or in the form of audio response. A user may then choose from one or more suggested characteristics of the suggested calendar entry to generate a final calendar entry within the scheduling system 100 (FIG. 1). For example, if a user executes the voice command “schedule me for Pilates this morning,” the scheduling system 100 may suggest a trainer based on the scheduling preferences 108 and available times for the suggested trainer. It should be understood that any of the scheduling operations defined herein may be also executed by one or more natural language commands. Further, it should be appreciated that the previous examples of spoken natural language commands may also be received by the scheduling system 100 in the form of a text string (e.g., via a text message, email, etc). In response to receiving such a text string, the scheduling system 100 would perform scheduling functions as specified in the text string (i.e., scheduling functions equivalent to those specified within the spoken equivalents of the text string).

One skilled in the art, having the benefit of reading this disclosure, would understand that the scheduling functions described above may be combined with conventional scheduling operations. For example, a user may double-click the available time slot indicator 318 to perform conventional scheduling activities. However, one should recognize that even conventional scheduling activities are enhanced by the scheduling system 100, which may identify one or more characteristics that may be satisfied by preferences within the scheduling preferences 108 (FIG. 1). For example, conventional scheduling activities may be streamlined by the scheduling system 100 reducing the amount of input required to generate a calendar entry. This may be manifested by one or more fields within a view for creating calendar entries to be eliminated or pre-populated with data from the scheduling preferences 108 (FIG. 1).

FIG. 4 illustrates the calendar-centric user interface 200 from FIG. 2 with an expanded time range generally indicated at 400. The calendar-centric user interface 400 includes a user profile frame 402, and a calendar frame 404. The calendar frame 404 may include a time range indicator 410, an available timeslot indicator 406, a private group calendar entry 422, a class calendar entry 408, and column headers 412-420. In shown embodiment, the calendar entries (e.g., 226 of FIG. 2) related to the schedulable resources 218-220 (FIG. 2) are represented per day beneath column headers 412-420. According to various embodiments, the expanded time frame enables a high level view of calendar entries with which a user profile is associated (i.e., scheduled) and/or calendar entries which a user may have interest based on the scheduling preferences 108 (FIG. 1). In one embodiment, calendar frame 404 may only visualize calendar entries for a user in which the user's profile is associated. For instance, if the user is associated with the private group calendar entry 422 than the private group calendar entry 422 will be visualized and other calendar entries not associated with the user will be excluded from the user's view (i.e., hidden). The exclusion of non-associated calendar entries may provide greater clarity to a user reviewing a schedule.

In another embodiment, the calendar frame 404 may suggest calendar entries for a user to create based on the scheduling preferences 108 (FIG. 1). For example, a user profile which includes previously scheduled Pilate classes may prompt the scheduling system 100 to visualize calendar entries which match this scheduling preference, such as calendar entry 408. In another example, various patterns may be interpreted from the biographical data 106 (FIG. 1) and the scheduling preferences 108 (FIG. 1) as discussed above with regard to FIG. 1. For example, a user profile may indicate that a user is a senior citizen based on the biographical data 106 (FIG. 1). In this example, the scheduling system 100 may suggest activities which are age-appropriate. Likewise, the data store 104 (FIG. 1) may be interpreted by the scheduling system 100 to identify past calendar entries created by other senior citizens. In this way, the scheduling system 100 may provide sufficient underlying data for the calendar frame 404 to make intelligent scheduling suggestions to a user. Continuing with this example, the scheduling system 100 may also suggest calendar entry partners (i.e., other user profiles) who share common interests (e.g., Pilates) and are of similar ages.

In another example, a user's scheduling preferences may determine the most feasible times of day to make scheduling suggestions. In this example, a user who schedules classes primarily (e.g., more than a threshold percentage of the time) during weekday mornings may be recognized as someone who works full time. Such recognition may allow the scheduling system 100 to not suggest calendar entries which take place during hours in which the scheduling system 100 considers the user to be unavailable. Further, such recognition may also determine that weekends are fully available based on the scheduling preferences 108 (FIG. 1) and may suggest calendar entries during weekend days that would not otherwise be suggested during weekdays. It should be understood that any information within the biographical information 106 and the scheduling preferences 108 may be analyzed, and in some cases, compared against other user profiles and their associated data.

### Scheduling Processes

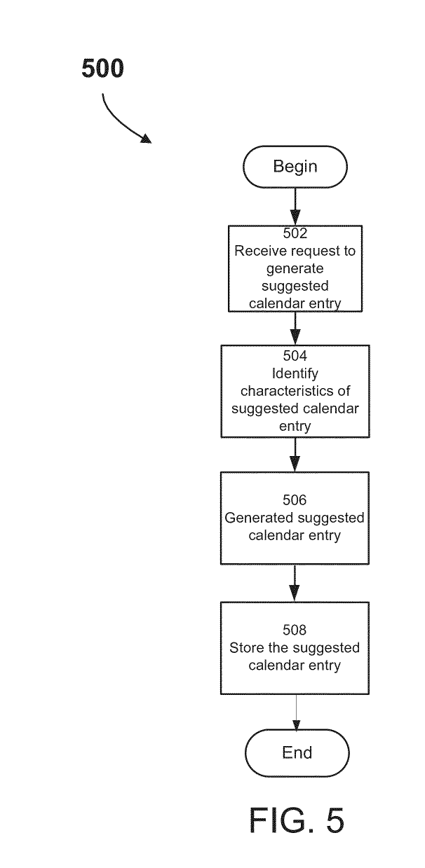

An example of the method implemented by the scheduling system 100 is illustrated in FIG. 5. In this example, the process 500 includes acts of receiving a request generate a suggested calendar entry, identify a plurality of characteristics of a suggested calendar entry to create during one or more time slots, the plurality of characteristics including at least one characteristic specified by the scheduling preference information, and generate a suggested calendar entry, the suggested calendar entry having the plurality of characteristics and requesting the plurality of resources during the at least one time slot. Although various examples below are from the perspective a client-user, it should be understood that process 500 may be directed to the creation of calendar entries for employees and other staff, such as professional personnel. This may include the ability for an employee/staff to utilize their profile and/or sub-profiles to create calendar entries (e.g., sessions, classes, available timeslot for classes, general availability, etc). Process 500 begins at 502.

In act 502, a request to create a calendar entry is received by the scheduling system 100 (FIG. 1). According to various examples, the scheduling system 100 receives the scheduling request via one or more components of the UI interface library 114 (FIG. 1). The request may include a reference to one or more time slots, one or more resources, and an identifier of one or more user profiles. In some examples, a single user profile may be identified within the request. In other examples, a plurality of user profiles may be identified within the request to create a group calendar entry. In various examples, the request to create a calendar entry is received from the user 110 (FIG. 1) via the network 112 (FIG. 1). In this example, the user 110 (FIG. 1) may access the scheduling system via a computer system, such as the computer 602 in FIG. 6. In these examples, the request may result from the user 110 (FIG. 1) executing functions (e.g., drag-and-drop operations) of the scheduling system 100 (FIG. 1) via visualized controls from the UI interface library 114 (FIG. 1).

In some embodiments, requests may be automatically generated in conjunction with, or in response to, other system functions. For example, according to one embodiment, the scheduling system 100 (FIG. 1) receives and interprets a request by a user to access (e.g., log on to) the system as a request to create a suggested calendar entry. Further, it is to be appreciated that, in some embodiments, the scheduling system 100 may reference data stored outside of the request to determine the identifier included within the request. For example, the scheduling system 100 may reference data stored outside of the request that identifies a currently logged on and authenticated user when determining the user profile included within and identified by the request.

In act 504, the scheduling system 100 (FIG. 1) identifies one or more characteristics of the suggested calendar entry to create. In some examples, the scheduling system 100 (FIG. 1) determines one or more characteristics of the calendar entry based on the one or more received user profiles. In one example, previously defined calendar entries may be used to determine the characteristics of the suggested calendar entry. In this example, if a time slot identified in the request has been previously scheduled as Pilates, the scheduling system 100 (FIG. 1) will determine the characteristics based on the previously created Pilates calendar entry. In another example, the scheduling patterns of a user may be analyzed by the scheduling system 100 (FIG. 1). For instance, if the scheduling preferences 108 (FIG. 1) of a user profile indicate that a user is most likely to generate a Pilates calendar entry during weekday mornings, a request to schedule including a weekday morning timeslot would result in the scheduling system 100 determining characteristics for a suggested Pilates calendar entry. In another example, the scheduling patterns and identification of previously created calendar entries may be used in combination whenever advantageous. For example, if no previously created calendar entry exists in the requested time slot, scheduling patterns may be examined to determine what characteristics (e.g., a resource to reserve) should be identified for a suggested calendar entry.

As discussed above with reference to FIG. 1, the plurality of characteristics may include one or more resources. In act 504, the scheduling system 100 (FIG. 1) may determine the availability of the one or more resources, and if one or more is determined to be unavailable, suggest alternate resources which may satisfy the scheduling request.

In one embodiment, the one or more received profiles are sub-profiles as described above with reference to FIGS. 1-4. In this embodiment, the sub-profile may provide additional, narrowed, characteristics that the scheduling system 100 may used in determining characteristics for a suggested calendar entry.

In at least one embodiment, information within the data store 104 (FIG. 1) associated with the requested time slot may indicate characteristics for the suggested calendar entry. For example, if a requested time slot includes a preference indicator, such as the preference indicator 244 discussed above in regards to FIG. 2, then the preference indicator will assist the scheduling system 100 in identifying characteristics.

In another embodiment, the request to generate a suggested calendar entry is received in act 502 includes an identifier of an existing calendar entry to update. In this embodiment, the scheduling system 100 (FIG. 1) determines one or more characteristics to update in the existing calendar entry based on the one or more received user profiles, and the existing calendar entry. For example, if the request to schedule is the result of a user requesting to join a class or private group calendar entry, then the calendar entry will be updated accordingly. In this example, the calendar entry may be updated to include an additional reference to the requesting user's profile. Further, the calendar entry status indicator, such as the calendar entry status indicator 204 of FIG. 2 may be updated to visualize the change to the updated calendar entry.

In act 506, a calendar entry reserving one or more resources during the time slot is generated whole or in part based on the suggested calendar entry. The new calendar entry includes a reference to the one or more user profiles, the one or more resources, and a reference to the one or more time slots. In one example, the UI interface library 114 (FIG. 1) updates various UI components to include the new calendar entry. For example, the calendar-centric user interface 200 of FIG. 2 may be updated to include the generated calendar entry within the calendar frame 204 (FIG. 2). Particular examples of these various UI components are discussed above with reference to FIGS. 2-4.

In act 508 the scheduling system 100 (FIG. 1) stores the created calendar entry in the data store 104. In various examples, the new calendar entry is associated with the one or more user profiles from the scheduling request received in act 502. In these examples, the generated calendar entry may be used by the scheduling system 100 (FIG. 1) to create future calendar entries.

Process 500 ends at 508. Scheduling requests received by the scheduling system 100 (FIG. 1) in accord with process 500 enables a user to create one or more calendar entries based on characteristics associated with one or more user profiles. In this way, processes in accord with process 500 provide users with a streamlined way of creating calendar entries without having to manually enter characteristics based on intelligent decisions by the scheduling system 100.

Process 500 depicts one sequence of acts in a particular example. The acts included in process 500 may be performed by, or using, one or more computer systems, such as the computer system 602 of FIG. 6. Some acts are optional and, as such, may be omitted in accord with one or more examples. Additionally, the order of the acts can be altered, or others acts can be added, without departing from the scope of the systems and methods disclosed herein. In addition, as discussed above, in at least one example, the acts are performed on a particular, specially configured machine, namely a computer system configured according to the examples disclosed herein.

### Computer System

As discussed above with regard to FIG. 1, various aspects and functions described herein may be implemented as specialized hardware or software components executing in one or more computer systems. There are many examples of computer systems that are currently in use. These examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system or may be distributed among a plurality of computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, examples are not limited to executing on any particular system or group of systems. Further, aspects and functions may be implemented in software, hardware or firmware, or any combination thereof. Thus, aspects and functions may be implemented within methods, acts, systems, system elements and components using a variety of hardware and software configurations, and examples are not limited to any particular distributed architecture, network, or communication protocol.

Referring to FIG. 6, there is illustrated a block diagram of a distributed computer system 600, in which various aspects and functions are practiced. As shown, the distributed computer system 600 includes one more computer systems that exchange information. More specifically, the distributed computer system 600 includes computer systems 602, 604 and 606. As shown, the computer systems 602, 604 and 606 are interconnected by, and may exchange data through, a communication network 608. The network 608 may include any communication network through which computer systems may exchange data. To exchange data using the network 608, the computer systems 602, 604 and 606 and the network 608 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST and Web Services. To ensure data transfer is secure, the computer systems 602, 604 and 606 may transmit data via the network 608 using a variety of security measures including, for example, TLS, SSL or VPN. While the distributed computer system 600 illustrates three networked computer systems, the distributed computer system 600 is not so limited and may include any number of computer systems and computing devices, networked using any medium and communication protocol.

As illustrated in FIG. 6, the computer system 602 includes a processor 610, a memory 612, an interconnection element 614, an interface 616 and data storage element 618. To implement at least some of the aspects, functions and processes disclosed herein, the processor 610 performs a series of instructions that result in manipulated data. The processor 610 may be any type of processor, multiprocessor or controller. Some example processors include commercially available processors such as an Intel Xeon, Itanium, Core, Celeron, or Pentium processor, an AMD Opteron processor, an Apple A4 or A5 processor, a Sun UltraSPARC or IBM Power5+ processor and an IBM mainframe chip. The processor 610 is connected to other system components, including one or more memory devices 612, by the interconnection element 614.

The memory 612 stores programs and data during operation of the computer system 602. Thus, the memory 612 may be a relatively high performance, volatile, random access memory such as a dynamic random access memory (“DRAM”) or static memory (“SRAM”). However, the memory 612 may include any device for storing data, such as a disk drive or other nonvolatile storage device. Various examples may organize the memory 612 into particularized and, in some cases, unique structures to perform the functions disclosed herein. These data structures may be sized and organized to store values for particular data and types of data.

Components of the computer system 602 are coupled by an interconnection element such as the interconnection element 614. The interconnection element 614 may include one or more physical busses, for example, busses between components that are integrated within a same machine, but may include any communication coupling between system elements including specialized or standard computing bus technologies such as IDE, SCSI, PCI and InfiniBand. The interconnection element 614 enables communications, such as data and instructions, to be exchanged between system components of the computer system 602.

The computer system 602 also includes one or more interface devices 616 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 602 to exchange information and to communicate with external entities, such as users and other systems.

The data storage element 618 includes a computer readable and writeable nonvolatile, or non-transitory, data storage medium in which instructions are stored that define a program or other object that is executed by the processor 610. The data storage element 618 also may include information that is recorded, on or in, the medium, and that is processed by the processor 610 during execution of the program. More specifically, the information may be stored in one or more data structures specifically configured to conserve storage space or increase data exchange performance. The instructions may be persistently stored as encoded signals, and the instructions may cause the processor 610 to perform any of the functions described herein. The medium may, for example, be optical disk, magnetic disk or flash memory, among others. In operation, the processor 610 or some other controller causes data to be read from the nonvolatile recording medium into another memory, such as the memory 612, that allows for faster access to the information by the processor 610 than does the storage medium included in the data storage element 618. The memory may be located in the data storage element 618 or in the memory 612, however, the processor 610 manipulates the data within the memory, and then copies the data to the storage medium associated with the data storage element 618 after processing is completed. A variety of components may manage data movement between the storage medium and other memory elements and examples are not limited to particular data management components. Further, examples are not limited to a particular memory system or data storage system.

Although the computer system 602 is shown by way of example as one type of computer system upon which various aspects and functions may be practiced, aspects and functions are not limited to being implemented on the computer system 602 as shown in FIG. 6. Various aspects and functions may be practiced on one or more computers having a different architectures or components than that shown in FIG. 6. For instance, the computer system 602 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 602 may be a computer system including an operating system that manages at least a portion of the hardware elements included in the computer system 602. In some examples, a processor or controller, such as the processor 610, executes an operating system. Examples of a particular operating system that may be executed include a Windows-based operating system, such as, Windows NT, Windows 2000 (Windows ME), Windows XP, Windows Vista or Windows 7 operating systems, available from the Microsoft Corporation, a MAC OS System X operating system or an iOS operating system available from Apple Computer, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular operating system.

The processor 610 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, C# (C-Sharp), Python, or JavaScript. Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements, e.g. specialized hardware, executable code, data structures or objects, which are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. A system configured to schedule at least one time slot of a plurality of time slots, the system comprising:
a memory;
at least one processor coupled to the memory; and
a scheduling component executable by the at least one processor and configured to:
receive a first request to generate a suggested calendar entry, the first request including an identifier of a spa, health, or fitness service and a plurality of identifiers corresponding to a plurality of scheduling profiles, the plurality of scheduling profiles including at least one scheduling profile of a client and at least one scheduling profile of a person to provide the spa, health, or fitness service, each scheduling profile of the plurality of scheduling profiles being associated with scheduling preference information identifying one or more preferred time slots and one or more preferred resources;
identify, based on the plurality of scheduling profiles and the spa, health, or fitness service, a plurality of characteristics of the suggested calendar entry, the plurality of characteristics including at least one characteristic specified by the scheduling preference information;
determine, based on the plurality of characteristics, that a plurality of resources are available during the at least one time slot, the plurality of resources including the person to provide the spa, health, or fitness service; and
generate the suggested calendar entry for the at least one time slot, the suggested calendar entry having the plurality of characteristics, requesting the plurality of resources during the at least one time slot, and identifying each scheduling profile of the plurality of scheduling profiles.

2. The system of claim 1, wherein at least one scheduling profile of the plurality of scheduling profiles includes biographical information.

3. The system of claim 1, wherein the scheduling preference information is manually created.

4. The system of claim 1, wherein the scheduling component is configured to generate the scheduling preference information based on at least one previous calendar entry.

5. The system of claim 1, wherein the scheduling preference information includes one or more characteristics from at least one previous calendar entry, and the scheduling component is configured to:
determine whether at least one characteristic of the plurality of characteristics of the suggested calendar entry matches the one or more characteristics of the at least one previous calendar entry; and
apply, in response to determining the at least one characteristic matches the one or more characteristics, at least one other characteristic of the at least one previous calendar entry to the suggested calendar entry.

6. The system of claim 1, wherein the scheduling component is further configured to:
receive a second request to schedule the at least one time slot of the plurality of time slots, the second request including an identifier of an additional scheduling profile;
update the suggested calendar entry based on the additional scheduling profile; and
display the suggested calendar entry within a view, the view including a representation of each scheduling profile of the plurality of scheduling profiles and the additional scheduling profile.

7. The system of claim 1, wherein the plurality of resources includes at least one of an identified space and equipment.

8. The system of claim 7, wherein the plurality of characteristics of the suggested calendar entry change based on a number of scheduling profiles associated with the suggested calendar entry.

9. (canceled)

10. The system of claim 1, wherein the at least one time slot is configured by one or more characteristics, the one or more characteristics including a time period comprising at least one of a start time and an end time.

11. The system of claim 10, wherein the at least one time slot is selected based on at least one scheduling profile of the plurality of scheduling profiles.

12. The system of claim 10, wherein the at least one time slot is configured with predefined characteristics.

13. The system of claim 1, wherein the first request is generated via a drag-and-drop operation.

14. The system of claim 1, wherein the first request is generated via a natural language command.

15. A method of scheduling at least one time slot of a plurality of time slots using a computer system including at least processor and memory coupled to the at least one processor, the method comprising:
receiving, by the computer system, a first request to generate a suggested calendar entry, the first request identifying a spa, health, or fitness service and a plurality of scheduling profiles including at least one scheduling profile of a client and at least one scheduling profile of a person to provide the spa, health, or fitness service, each scheduling profile of the plurality of scheduling profiles being associated with scheduling preference information identifying one or more preferred time slots and one or more preferred resources;
identifying, by the computer system based on the plurality of scheduling profiles and the spa, health, or fitness service, a plurality of characteristics of the suggested calendar entry, the plurality of characteristics including at least one characteristic specified by the scheduling preference information;
determining, by the computer system based on the plurality of characteristics, that a plurality of resources are available during the at least one time slot, the plurality of resources including the person to provide the spa, health, or fitness service; and
generating, by the computer system, the suggested calendar entry for the at least one time slot, the suggested calendar entry having the plurality of characteristics, requesting the plurality of resources during the at least one time slot, and identifying each scheduling profile of the plurality of scheduling profiles.

16. The method of claim 15, wherein identifying the plurality of characteristics of the suggested calendar entry includes identifying the plurality of characteristics based on a plurality of scheduling profiles including biographical information.

17. The method of claim 15, wherein the method further comprises generating the schedule preference information manually.

18. The method of claim 15, wherein the method further comprises generating the schedule preference information based on at least one previous calendar entry, the at least one previous calendar entry having a plurality characteristics.

19. The method of claim 15, wherein determining that the plurality of resources are available includes:
determining at least one resource is unavailable for the at least one time slot; and
suggesting, responsive to determining that the at least one resource unavailable, another resource which is available for the at least one time slot.

20. The method of claim 15, wherein the method further comprises:
receiving a second request to update the suggested calendar entry for the at least one time slot of the plurality of time slots, the second request identifying an additional scheduling profile;
updating the suggested calendar entry based on the additional scheduling profile; and
displaying the suggested calendar entry within a view, the view including a representation of each scheduling profile of the plurality of scheduling profiles and the additional scheduling profile.

21. The method of claim 15, wherein the method further comprises determining at least one characteristic of the plurality of characteristics based on at least one scheduling pattern.

22. The method of claim 21, wherein determining at least one characteristic of the plurality of characteristics based on at least one scheduling pattern further includes determining the scheduling pattern based on at least one previous calendar entry associated with the scheduling preference information.

23. A non-transitory computer readable medium storing instructions for scheduling at least one time slot of a plurality of time slots, the instructions being executable by at least one processor of a computer system, the instructions configured to instruct the computer system to:
receive a first request to generate a suggested calendar entry, the first request including an identifier of a spa, health, or fitness service and a plurality of identifiers corresponding to a plurality of scheduling profiles, the plurality of scheduling profiles including at least one scheduling profile of a client and at least one scheduling profile of a person to provide the spa, health, or fitness service, each scheduling profile of the plurality of scheduling profiles being associated with scheduling preference information identifying one or more preferred time slots and one or more preferred resources;
identify, based on the plurality of scheduling profiles and the spa, health, or fitness service, a plurality of characteristics of the suggested calendar entry, the plurality of characteristics including at least one characteristic specified by the scheduling preference information;
determine, based on the plurality of characteristics, that a plurality of resources are available during the at least one time slot, the plurality of resources including the person to provide the spa, health, or fitness service; and
generate the suggested calendar entry for the at least one time slot, the suggested calendar entry having the plurality of characteristics, requesting the plurality of resources during the at least one time slot, and identifying each scheduling profile of the plurality of scheduling profiles.

24. The non-transitory computer readable medium of claim 23, wherein at least one scheduling profile of the plurality of scheduling profiles includes biographical information.

25. The non-transitory computer readable medium of claim 23, wherein the instructions are further configured to instruct the computer system to generate the schedule preference information based on at least one previous calendar entry.

26. The non-transitory computer readable medium of claim 23, wherein the plurality of resources includes at least one of an identified space, and equipment.

27. The non-transitory computer readable medium of claim 23, wherein the plurality of characteristics is determined based on at least one scheduling pattern.

28. The non-transitory computer readable medium of claim 27, wherein the at least one scheduling pattern is determined by at least one previous calendar entry associated with the scheduling preference information.

29. The non-transitory computer readable medium of claim 26, wherein the at least one time slot includes at least one calendar entry indicating availability of at least one resource of the plurality of resources.

30. The non-transitory computer readable medium of claim 23, wherein the at least one time slot includes at least one scheduling preference indicator, the scheduling preference indicator indicating at least one predefined characteristic of the at least one time slot.

31. The system of claim 1, wherein the schedule preference information identifies a service capacity preferred by the person to provide the spa, health, or fitness service, the suggested calendar entry is a group calendar entry, and the at least one scheduling profile of the client includes at least two scheduling profiles of clients.
